(19) United States
(12) Patent Application Publication
(10) Pub. No.: US 2018/0157135 A1
(43) Pub. Date: Jun. 7, 2018

(54) PIXEL STRUCTURE, ARRAY SUBSTRATE, AND LIQUID CRYSTAL DISPLAY PANEL

(71) Applicant: Shenzhen China Star Optoelectronics Technology Co. Ltd., Shenzhen (CN)

(72) Inventors: Jinjie WANG, Shenzhen (CN); Jinbo GUO, Guangdong (CN)

(73) Assignee: Shenzhen China Star Optoelectronics Technology Co. Ltd., Shenzhen (CN)

(21) Appl. No.: 14/897,674

(22) PCT Filed: Sep. 14, 2015
(86) PCT No.: PCT/CN2015/089506

§ 371 Date: Feb. 7, 2018

(30) Foreign Application Priority Data
Sep. 10, 2015 (CN) 201510574885.0

(51) Int. Cl. G02F 1/1362; G02F 1/1335; G02F 1/1343

(52) U.S. Cl. CPC G02F 1/136286; G02F 1/133514; G02F 2001/134345; G02F 2201/123; G02F 2201/121; G02F 1/134309

(57) ABSTRACT

Provided is a pixel structure, an array substrate, and a liquid crystal display panel. In the pixel structure, a sub-pixel region is horizontally arranged, and a data line passes through the sub-pixel region in a vertical direction, so that parasitic capacitance between the data line and a pixel electrode is effectively reduced, and a phenomenon of vertical crosstalk is eliminated. A distance between the data line and common electrode is configured to be greater than a predetermined distance, thereby avoiding arrangement of an additional black matrix. This improves aperture ratio and transmittance of the panel, and optimizes display effects.

### CROSS-REFERENCE TO RELATED APPLICATIONS

The present application claims the priority of Chinese patent application CN 201510574885.0, entitled “Pixel structure, array substrate, and liquid crystal display panel” and filed on Sep. 10, 2015, the entirety of which is incorporated herein by reference.

### FIELD OF THE INVENTION

The present disclosure relates to the field of display technologies, and in particular, to a pixel structure, an array substrate with the pixel structure, and a liquid crystal display panel with the array substrate.

### BACKGROUND OF THE INVENTION

With constant development of liquid crystal display technologies, liquid crystal display panels, as display components, have been widely used in electronic products, such as mobile phones, digital cameras, and PDA. The liquid crystal display panel has a pixel structure.

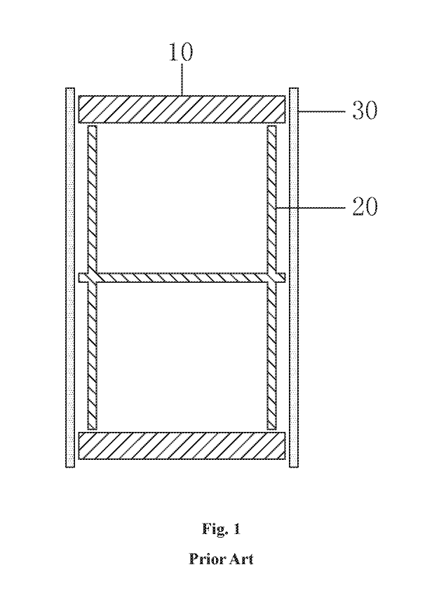

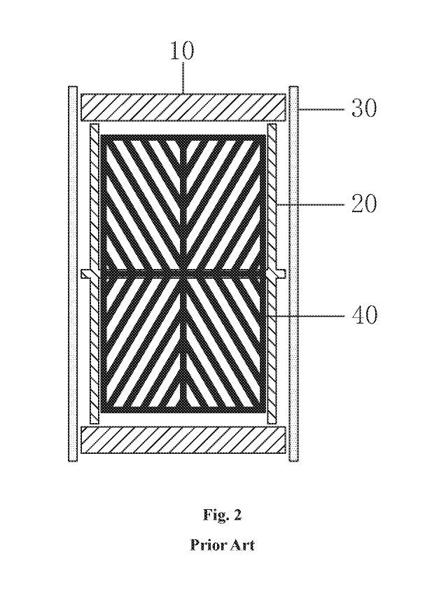

FIG. 1 schematically shows the structure of a pixel structure (a pixel electrode is not show) in the prior art, and FIG. 2 schematically shows the structure of the pixel structure of FIG. 1 added with a pixel electrode. With reference to FIGS. 1 and 2, the pixel structure in the prior art comprises a pixel electrode 40, a scan line 10, two data lines 30, and three common electrodes 20. A sub-pixel region defined by the scan line 10 and the common electrodes 20 is arranged in a vertical manner, and the scan line 10 is arranged to he parallel to a width direction of the sub-pixel region. Two of the common electrodes, respectively arranged at a left side and a right side of the sub-pixel region, are parallel to a length direction of the sub-pixel region. The two data lines 30, respectively arranged to be adjacent to the left side and the right side of the aforementioned two common electrodes, are parallel to the length direction of the sub-pixel region.

The pixel structure in the prior art has a detect as described in the following. A voltage difference between the data line 30 and adjacent common electrode will generate an electric field, which enables corresponding liquid crystal molecules to significantly deflect, and thus causes light leakage of the liquid crystal display panel along two sides of the pixel electrode 40. In order to overcome the defect of light leakage, a black matrix is generally covered above the common electrode and the adjacent data line 30 to shield light. However, due to use of the black matrix, an aperture ratio of the liquid crystal display panel will be considerably decreased, thereby influencing transmittance thereof. Eventually, it would be necessary to provide greater backlight brightness to satisfy brightness requirements of the entire liquid crystal display panel.

### SUMMARY OF THE INVENTION

The present disclosure intends to solve the following technical problem. Due to use of a pixel structure in the prior art, an aperture ratio and transmittance of a liquid crystal display panel are decreased significantly, and thus greater backlight brightness is necessary to satisfy brightness requirements of the entire liquid crystal display panel.

In order to solve the aforementioned technical problem, the present disclosure provides a pixel structure, an array substrate, and a liquid crystal display panel.

According to a first aspect of the present disclosure, a pixel structure is provided, comprising a scan line, a data line, a pixel electrode, and common electrodes,
wherein the scan line and the common electrodes define a sub-pixel region, which is parallel to the scan line in a length direction thereof and parallel to the data line in a width direction thereof, and
wherein the data line passes through the sub-pixel region and overlaps with the pixel electrode.

Preferably, the common electrodes comprise a first strip common electrode and a second strip common electrode, both being parallel to the width direction of the sub-pixel region, wherein the first strip common electrode and the second strip common electrode are located outside of short sides of the sub-pixel region, respectively, the first strip common electrode, the second strip common electrode, and the scan line defining the sub-pixel region, and
wherein the scan line is located between the first strip common electrode and the second strip common electrode.

Preferably, a distance between the data line and the first strip common electrode as well as a distance between the data line and the second strip common electrode are both greater than a predetermined distance.

Preferably, the distance between the data line and the first strip common electrode equals the distance between the data line and the second strip common electrode.

Preferably, the common electrodes further comprise a third strip common electrode parallel to the length direction of the sub-pixel region, and two ends of the third strip common electrode are respectively connected to the first strip common electrode and the second strip common electrode.

Preferably, the third strip common electrode is located in the sub-pixel region.

Preferably, the data line is located below the pixel electrode, which is divided, by a dividing electrode thereof, into a first sub-pixel electrode region and a second sub-pixel electrode region, wherein the dividing electrode coincides with a central line of the pixel electrode in a length direction thereof,
wherein both of the first sub-pixel region and the second sub-pixel region are symmetrical with respect to the data line, and
wherein each of the sub-pixel electrode regions is provided with a plurality of gaps thereon, which divides a corresponding sub-pixel electrode region into a plurality of separators, the plurality of gaps and the plurality of separators being alternately distributed.

Preferably, the separators on the first sub-pixel electrode region and corresponding separators on the second sub-pixel electrode region are disconnected above the data line, respectively, so as to form stripped openings in the pixel electrode above the data line along a length direction of the data line, thereby decreasing an overlapping area between the data line and the pixel electrode located above the data line.

According to a second aspect of the present disclosure, an array substrate is provided, comprising a base plate, and the above pixel structure, which is arranged on the base plate.

According to a third aspect of the present disclosure, a liquid crystal display panel is provided, comprising a color film substrate, the above array substrate, and a liquid crystal layer disposed between the color film substrate and the array substrate. The color film substrate and the array substrate are arranged opposite to each other.

Compared with the prior art, one or more embodiments of the aforementioned solution can have the following advantages or beneficial effects.

According to the pixel structure of the present disclosure, the sub-pixel region is arranged horizontally, and the data line passes through the sub-pixel region along a vertical direction, thereby effectively reducing parasitic capacitance generated between the data line and the pixel electrode and eliminating the phenomenon of vertical crosstalk. In addition, the sub-pixel region is arranged in a horizontal manner in the present disclosure, which obviously increases the distances between the data line and the common electrodes on both sides thereof, and thus the distances between the data line and the common electrodes on both sides thereof are each greater than a predetermined distance, thereby preventing evident deflection of liquid crystal molecules caused by insufficient electric field due to a voltage difference generated between the data line and the common electrode. Through such a design, a black matrix used for covering the data line and adjacent common electrodes can be effectively decreased in size, or the black matrix can be completely removed. As a result, the aperture ratio and the transmittance of the liquid crystal display panel can be enhanced, thus optimizing display effects.

Other features and advantages of the present disclosure will be further explained in the following description, and partly become self-evident therefrom, or be understood through implementation of the present disclosure. The objectives and advantages of the present disclosure will be achieved through the structure specifically pointed out in the description, claims, and the accompanying drawings.

### BRIEF DESCRIPTION OF THE INVENTION

The drawings are provided for further understanding of the present disclosure, and constitute one part of the description. They serve to explain the present disclosure in conjunction with the embodiments, rather than to limit the present disclosure in any manner. In the drawings:

FIG. 1 schematically shows the structure of a pixel structure (a pixel electrode is not shown) in the prior art;

FIG. 2 schematically shows the structure of the pixel structure indicated in FIG. 1 added with a pixel electrode;

FIG. 3 schematically shows the structure of a pixel structure (a pixel electrode is not shown) according to an embodiment of the present disclosure;

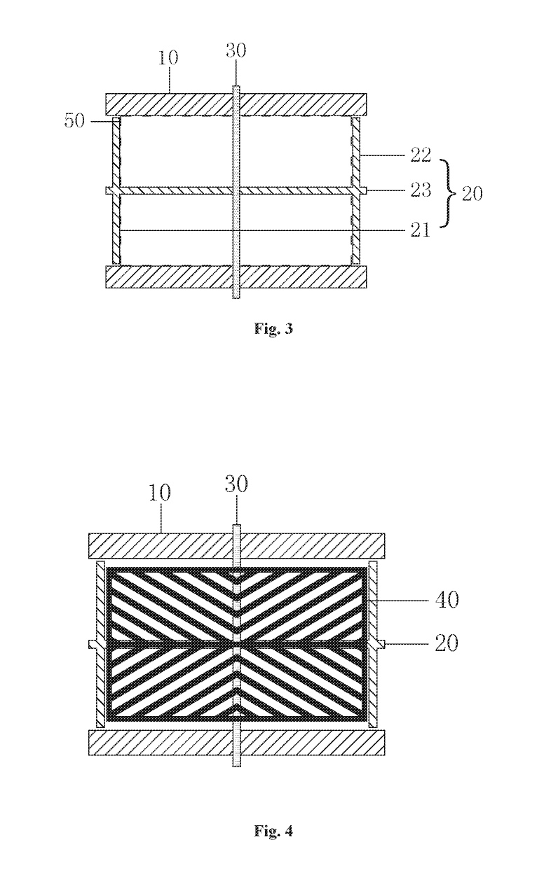

FIG. 4 schematically shows the structure of the pixel structure indicated in FIG. 3 added with a pixel electrode;

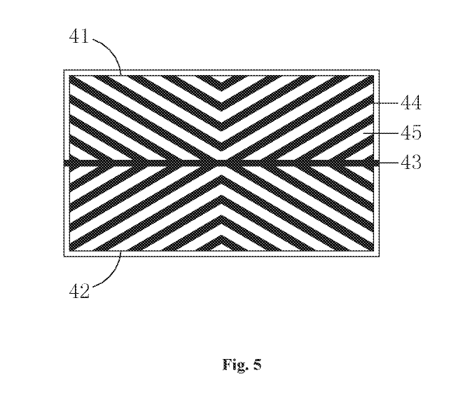

FIG. 5 schematically shows the structure of the pixel electrode indicated in FIG. 4;

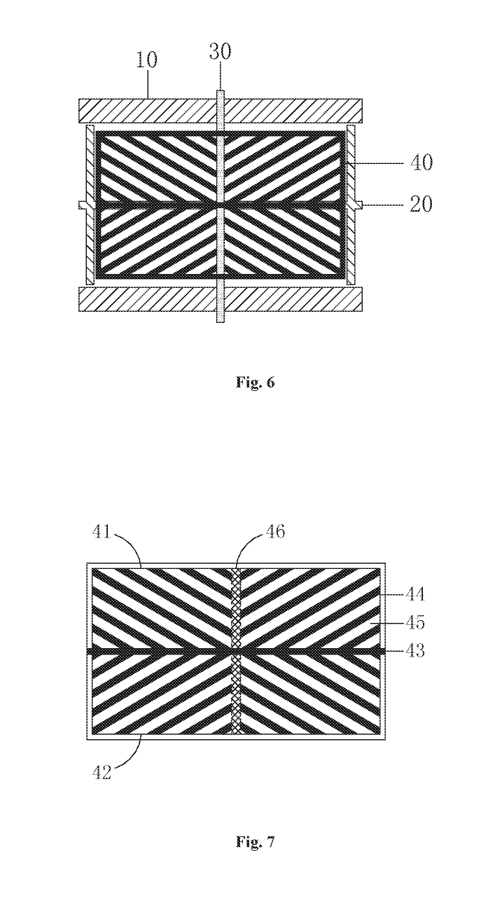

FIG. 6 schematically shows another structure of the pixel structure indicated in FIG. 3 added with a pixel electrode; and

FIG. 7 schematically shows the structure of the pixel electrode indicated in FIG. 6.

### DETAILED DESCRIPTION OF THE EMBODIMENTS

The present disclosure will be explained by reference to the following detailed description of embodiments taken in connection with the accompanying drawings, whereby it can be readily understood how to solve the technical problem by the technical means according to the present disclosure and achieve the technical effects thereof, and thus the technical solution according to the present disclosure can be implemented. It is important to note that as long as there is no conflict, combinations of the above-described embodiments and of technical features therein are possible, and technical solutions obtained in this manner are intended to be within the scope of the present disclosure.

The technical problem to be solved by the embodiments of the present disclosure can be described as follows. Due to use of a pixel structure in the prior art, an aperture ratio and transmittance of a liquid crystal display panel are considerably reduced, and thus greater backlight brightness is necessary to meet the brightness requirements of the entire panel. In order to solve the above technical problem, in the embodiment of the present disclosure, a pixel structure which can significantly enhance the aperture ratio and the transmittance of a liquid crystal display panel is provided.

FIG. 3 schematically shows the structure of a pixel structure (a pixel electrode is not shown) according to an embodiment of the present disclosure. According to the embodiment, the pixel structure mainly comprises an active element (not shown in the drawing), two scan lines 10, one data line 30, one pixel electrode 40, and three strip common electrodes 20. The active element is preferably in the form of a thin film transistor, and is electrically connected to the scan lines 10, the data line 30, and the pixel electrode 40, respectively. The three strip common electrodes 20 are respectively a first strip common electrode 21, a second strip common electrode 22, and a third strip common electrode 23.

In the present embodiment, a sub-pixel region 50 is defined by the two horizontally arranged scan lines 10 and the two longitudinally arranged strip common electrodes (21, 22). The sub-pixel region 50 corresponds to one sub-pixel on a color film substrate, and the pixel electrode 40 is covered on the sub-pixel region 50. The sub-pixel region 50 is horizontally arranged. That is, a length direction of the sub-pixel region 50 is parallel to the scan lines 10 in a horizontal direction thereof, while a width direction of the sub-pixel region 50 is parallel to the first strip common electrode 21 and the second strip common electrode 22 in their vertical direction.

FIGS. 4 and 6 show two pixel structures each provided with the pixel electrode 40. With reference to FIGS. 4 and 6, the pixel electrode 40 arranged in the sub-pixel region 50 is arranged in a horizontal manner also.

The two scan lines 10 are parallel to the length direction of the sub-pixel region 50 and are respectively arranged outside of upper and lower sides of the sub-pixel region 50. Among the three strip common electrodes 20, both the first strip common electrode 21 and the second strip common electrode 22 are parallel to the width direction of the sub-pixel region 50, while the third strip common electrode 23 is parallel to the length direction of the sub-pixel region 50. The first strip common electrode 21 and the second strip common electrode 22 are respectively arranged outside of left and right sides of the sub-pixel region 50. In particular, a distance between the third strip common electrode 23 and the upper side of the sub-pixel region 50 is equal to a distance between the third strip common electrode 23 and the lower side of the sub-pixel region 50. More particularly, the three strip common electrodes form a structure of the letter H.

According to the pixel structure of the present disclosure, the data line 30 arranged through the sub-pixel region 50 is parallel to the width direction of the sub-pixel region 50. A distance from the data line 30 to the first strip common electrode 21 is greater than a predetermined distance, and at the same time, a distance from the data line 30 to the second strip common electrode 21 is greater than the predetermined distance. In this case, the following requirements should be satisfied by the predetermined distance. An electric filed generated under a voltage difference between the data line 30 and the first common electrode 21 is insufficient to enable liquid crystal molecules to deflect significantly, and an electric filed generated under a voltage difference between the data line 30 and the second common electrode 22 is insufficient to enable liquid crystal molecules to deflect significantly.

According to the pixel structure of the present embodiment, the sub-pixel region 50 is arranged horizontally, and the data line 30 is arranged through the sub-pixel region 50 in a vertical direction, thereby effectively decreasing a parasitic capacitance between the data line 30 and the pixel electrode 40 and eliminating the phenomenon of vertical crosstalk. For example, the sub-pixel region 50 can have a length three times its width. This enables both the data line 30 within the sub-pixel region 50 and the pixel electrode 40 to have a length approximate to one third of a length in the prior art. In this case, according to the present embodiment, the parasitic capacitance generated between the data line 30 and the pixel electrode 40 can be decreased to one third of the parasitic capacitance in the prior art. As a result, when the liquid crystal display panel displays a crosstalk image, influences caused by the parasitic capacitance on the pixel electrode 40 can be reduced significantly, thereby eliminating the phenomenon of vertical crosstalk and enhancing the display quality of the image. In addition, according to the present embodiment, the sub-pixel region 50 is horizontally arranged, to obviously increase distances between the data line 30 and the two common electrodes (21, 22) on the two sides thereof. Thus, the distances between the data line 30 and the common electrodes are greater than the predetermined distance, thereby ensuring that the electric filed generated under the voltage difference between the data line 30 and the common electrode is insufficient to enable the liquid crystal molecules to deflect significantly. With such a design, a black matrix used for covering the data line and adjacent common electrodes can be effectively reduced in area, or the black matrix can be completely removed, thereby enhancing the aperture ratio and the transmittance of the liquid crystal display panel and optimizing display effects.

In one preferred embodiment of the present disclosure, the data line 30 is arranged through a central area of the sub-pixel region 50. In particular, the data line 30 is located in a central position of the sub-pixel region 50. That is, the distance between the data line 30 and the first strip common electrode 21 equals the distance between the data line 30 and the second strip common electrode 22. Such an arrangement renders the display effects of the liquid crystal display panel more homogeneous.

The specific structure of the pixel electrode 40 will be illustrated in detail in conjunction with FIGS. 4 to 7 in the following.

As shown in FIGS. 4 to 7, the data line 30 is located below the pixel electrode 40. The pixel electrode 40 comprises a dividing electrode 43, which divides the pixel electrode 40 into two sub-pixel electrode regions, i.e., a first sub-pixel electrode region 41 and a second sub-pixel electrode region 42. In particular, the dividing so electrode 43 is parallel to the pixel electrode 40 in its length direction and located in a central region of the pixel electrode 40. The first sub-pixel electrode region 41 and the second sub-pixel electrode region 42 are symmetrical with respect to the dividing electrode 43. In addition, a left portion and a right portion of the first sub-pixel electrode region 41 are symmetrical with respect to the data line 30. Similarly, a left portion and a right portion of the second sub-pixel electrode region 42 are symmetrical with respect to the data line 30 also.

Each of the sub-pixel electrode regions is provided with a plurality of gaps 45 thereon, and these gaps 45 divide each of the sub-pixel electrode regions into a plurality of separators 44. The plurality of gaps 45 and the plurality of separators 44 are distributed alternately.

According to the present embodiment, the pixel electrode 40 is divided by the dividing electrode 43 into the first sub-pixel electrode region 41 and the second sub-pixel electrode region 42 that are symmetrical to each other. Meanwhile, the data line 30 is parallel to the pixel electrode 40 in its width direction, and the data line 30 is located in a central region of the pixel electrode 40. Such an arrangement renders areas of the sub-pixel electrode regions more homogeneous. Furthermore, the pixel electrode 40 of the present embodiment can be used to provide the liquid crystal display panel with better resolution.

In one preferred embodiment of the present disclosure, with specific reference to FIGS. 4 and 5, the gaps 45 in the left portion and the right portion of the first sub-pixel electrode region 41 are symmetrical with respect to the data line 30 and are connected to each other above the data line 30. The separators 44 in the left portion and the right portion of the first sub-pixel electrode region 41 are symmetrical with respect to the data line 30 and connected to each other above the data line 30. The gaps 45 in the left portion and the right portion of the second sub-pixel electrode region 42 are symmetrical with respect to the data line 30 and connected to each other above the data line 30. The separators 44 in the left portion and the right portion of the second sub-pixel electrode region 42 are symmetrical with respect to the data line 30 and connected to each other above the data line 30.

In one preferred embodiment of the present disclosure, with specific reference to FIGS. 6 and 7, the separators 44 opposite to the first sub-pixel electrode region 41 are disconnected above the data line 30, while the separators 44 opposite to the second sub-pixel electrode region 42 are disconnected above the data line 30. Such being the case, a stripped opening 46 is formed in the pixel electrode 40 which is above the data line 30 along the length direction of the data line 30, thereby reducing an overlapping area between the data line 30 and the pixel electrode 40 above the data line 30. According to the present embodiment, the parasitic capacitance generated between the data line 30 and the pixel electrode 40 can be further reduced, thereby further facilitating elimination of the phenomenon of vertical crosstalk.

Correspondingly, according to an embodiment of the present disclosure, an array substrate is further provided, wherein the array substrate comprises a base plate and the pixel structure according to the above embodiment. The pixel structure forms on the base plate.

Correspondingly, according to an embodiment of the present disclosure, a liquid crystal display panel is provided, wherein the liquid crystal display panel can be used in such electronic products as mobile phones, digital cameras, PDAs, and the like. The liquid crystal display panel of the present embodiment mainly comprises a color film substrate, the array substrate as described in the above embodiment, and a liquid crystal layer. Specifically, the array substrate is arranged opposite to the color film substrate, and the liquid crystal layer is disposed between the color film substrate and the array substrate.

While the embodiments of the present disclosure are described above, the description should not be construed as limitations of the present disclosure, but merely as embodiments for readily understanding the present disclosure. Anyone skilled in the art, within the spirit and scope of the present disclosure, can make amendments or modification to the implementing forms and details of the embodiments. Hence, the scope of the present disclosure should be subject to the scope defined in the claims.

1. A pixel structure, comprising a scan line, a data line, a pixel electrode, and common electrodes,
wherein the scan line and the common electrodes define a sub-pixel region, which is parallel to the scan line in a length direction thereof and parallel to the data line in a width direction thereof, and
wherein the data line passes through the sub-pixel region and overlaps with the pixel electrode.

2. The pixel structure according to claim 1, wherein the common electrodes comprise a first strip common electrode and a second strip common electrode, both being parallel to the width direction of the sub-pixel region,
wherein the first strip common electrode and the second strip common electrode are located outside of short sides of the sub-pixel region, respectively, the first strip common electrode, the second strip common electrode, and the scan line defining the sub-pixel region, and
wherein the scan line is located between the first strip common electrode and the second strip common electrode.

3. The pixel structure according to claim 2, wherein a distance between the data line and the first strip common electrode as well as a distance between the data line and the second strip common electrode are both greater than a predetermined distance.

4. The pixel structure according to claim 3, wherein the distance between the data line and the first strip common electrode equals the distance between the data line and the second strip common electrode.

5. The pixel structure according to claim 4, wherein the data line is located below the pixel electrode, which is divided, by a dividing electrode thereof, into a first sub-pixel electrode region and a second sub-pixel electrode region,
wherein the dividing electrode coincides with a central line of the pixel electrode in a length direction thereof,
wherein both of the first sub-pixel region and the second sub-pixel region are symmetrical with respect to the data line, and
wherein each of the sub-pixel electrode regions is provided with a plurality of gaps thereon, which divides a corresponding sub-pixel electrode region into a plurality of separators, the plurality of gaps and the plurality of separators being alternately distributed.

6. The pixel structure according to claim 5, wherein the separators on the first sub-pixel electrode region and corresponding separators on the second sub-pixel electrode region are disconnected above the data line, respectively, so as to form stripped openings in the pixel electrode above the data line along a length direction of the data line, thereby decreasing an overlapping area between the data line and the pixel electrode located above the data line.

7. The pixel structure according to claim 2, wherein the common electrodes further comprise a third strip common electrode parallel to the length direction of the sub-pixel region, and
wherein two ends of the third strip common electrode are respectively connected to the first strip common electrode and the second strip common electrode.

8. The pixel structure according to claim 7, wherein the data line is located below the pixel electrode, which is divided, by a dividing electrode thereof, into a first sub-pixel electrode region and a second sub-pixel electrode region,
wherein the dividing electrode coincides with a central line of the pixel electrode in a length direction thereof,
wherein both of the first sub-pixel region and the second sub-pixel region are symmetrical with respect to the data line, and
wherein each of the sub-pixel electrode regions is provided with a plurality of gaps thereon, which divides a corresponding sub-pixel electrode region into a plurality of separators, the plurality of gaps and the plurality of separators being alternately distributed.

9. The pixel structure according to claim 8, wherein the separators on the first sub-pixel electrode region and corresponding separators on the second sub-pixel electrode region are disconnected above the data line, respectively, so as to form stripped openings in the pixel electrode above the data line along a length direction of the data line, thereby decreasing an overlapping area between the data line and the pixel electrode located above the data line.

10. The pixel structure according to claim 7, wherein the third strip common electrode is located in the sub-pixel region.

11. The pixel structure according to claim 10, wherein the data line is located below the pixel electrode, which is divided, by a dividing electrode thereof, into a first sub-pixel electrode region and a second sub-pixel electrode region,
wherein the dividing electrode coincides with a central line of the pixel electrode in a length direction thereof,
wherein both of the first sub-pixel region and the second sub-pixel region are symmetrical with respect to the data line, and
wherein each of the sub-pixel electrode regions is provided with a plurality of gaps thereon, which divides a corresponding sub-pixel electrode region into a plurality of separators, the plurality of gaps and the plurality of separators being alternately distributed.

12. The pixel structure according to claim 11, wherein the separators on the first sub-pixel electrode region and corresponding separators on the second sub-pixel electrode region are disconnected above the data line, respectively, so as to form stripped openings in the pixel electrode above the data line along a length direction of the data line, thereby decreasing an overlapping area between the data line and the pixel electrode located above the data line.

13. An array substrate, comprising:
a base plate; and
a pixel structure, which is arranged on the base plate, and comprises a scan line, a data line, a pixel electrode, and common electrodes,
wherein the scan line and the common electrodes define a sub-pixel region, which is parallel to the scan line in a length direction thereof and parallel to the data line in a width direction thereof, and
wherein the data line passes through the sub-pixel region and overlaps with the pixel electrode.

14. The array substrate according to claim 13, wherein the common electrodes comprise a first strip common electrode and a second strip common electrode, both being parallel to the width direction of the sub-pixel region,
wherein the first strip common electrode and the second strip common electrode are located outside of short sides of the sub-pixel region, respectively, the first strip common electrode, the second strip common electrode, and the scan line defining the sub-pixel region, and
wherein the scan line is located between the first strip common electrode and the second strip common electrode.

15. The array substrate according to claim 14, wherein a distance between the data line and the first strip common electrode as well as a distance between the data line and the second strip common electrode are both greater than a predetermined distance.

16. The array substrate according to claim 15, wherein the distance between the data line and the first strip common electrode equals the distance between the data line and the second strip common electrode.

17. A liquid crystal display panel, comprising:
a color film substrate;
an array substrate, which is arranged opposite to the color film substrate; and
a liquid crystal layer disposed between the color film substrate and the array substrate,
wherein the array substrate includes:
a base plate; and
a pixel structure, which is arranged on the base plate, and comprises a scan line, a data line, a pixel electrode, and common electrodes,
wherein the scan line and the common electrodes define a sub-pixel region, which is parallel to the scan line in a length direction thereof and parallel to the data line in a width direction thereof, and
wherein the data line passes through the sub-pixel region and overlaps with the pixel electrode.

18. The liquid crystal display panel according to claim 17, wherein the common electrodes comprise a first strip common electrode and a second strip common electrode, both being parallel to the width direction of the sub-pixel region,
wherein the first strip common electrode and the second strip common electrode are located outside of short sides of the sub-pixel region, respectively, the first strip common electrode, the second strip common electrode, and the scan line defining the sub-pixel region, and
wherein the scan line is located between the first strip common electrode and the second strip common electrode.

19. The liquid crystal display panel according to claim 18, wherein a distance between the data line and the first strip common electrode as well as a distance between the data line and the second strip common electrode are both greater than a predetermined distance.

20. The liquid crystal display panel according to claim 18, wherein the distance between the data line and the first strip common electrode equals the distance between the data line and the second strip common electrode.
